(19) United States
(12) Patent Application Publication
(10) Pub. No.: US 2026/0132086 A1
(43) Pub. Date: May 14, 2026

(54) MIXED METAL OXIDE NANOCOMPOSITE AND PROCESS OF MAKING THE NANOCOMPOSITE

(71) Applicant: IMAM MOHAMMAD IBN SAUD ISLAMIC UNIVERSITY, Riyadh (SA)

(72) Inventor: Ehab Abdelhamed Abdelrahman AHMED, Riyadh (SA)

(73) Assignee: IMAM MOHAMMAD IBN SAUD ISLAMIC UNIVERSITY, Riyadh (SA)

(21) Appl. No.: 18/932,066

(22) Filed: Oct. 30, 2024

(51) Int. Cl. C04B 35/465; C04B 35/626; C04B 35/64; C04B 38/00

(52) U.S. Cl. CPC C04B 35/465; C04B 35/62655; C04B 35/62675; C04B 35/64; C04B 38/0054; C04B 2235/3236; C04B 2235/3409; C04B 2235/441; C04B 2235/443; C04B 2235/6567; C04B 2235/781; C04B 2235/963

(57) ABSTRACT

A mixed metal oxide nanocomposite comprises magnesium, titanium, boron, and oxygen. The nanocomposite comprises a first phase of magnesium titanium oxide (MgTi₂O₅) and a second phase of magnesium borate (Mg₃B₂O₆). The first phase and the second phase are present as a homogeneous mixture within the nanocomposite and exhibit an orthorhombic crystal system. The nanocomposite is mesoporous with a mean pore diameter of 5 to 10 nm.

### BACKGROUND

### Technical Field

The present disclosure is directed to a mixed metal oxide nanocomposite and a method of producing the nanocomposite, and particularly relates to a magnesium titanium oxide (MgTi₂O₅) and magnesium borate (Mg₃B₂O₆) nanocomposite and a method for synthesizing the MgTi₂O₅/Mg₃B₂O₆ nanocomposite.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Mixed metal oxides have a wide range of applications, including catalysis, energy storage, environmental remediation, electronics, and biomedical fields. Versatile properties of mixed metal oxides can enhance reaction rates, facilitate pollutant removal, and enable advanced electronic devices; however, synthesis of mixed metal oxides faces challenges. Development of mixed metal oxide nanocomposites has garnered interest due to promising applications in catalysis, adsorption, and advanced material technologies. Traditional synthesis methods for the mixed metal oxide nanocomposite materials, including solid-state reactions and hydrothermal processes, generally require high temperatures, prolonged reaction times, and complex multistep procedures that lead to irregular particle sizes and poor reproducibility.

Techniques in traditional synthesis methods often result in inconsistent porosity and high operational costs, affecting the overall material performance of such metal oxide nanocomposites. Moreover, techniques are limited by high synthesis temperatures and a need for extensive milling and post-treatment steps, which can contribute to non-uniform particle size distribution. Overcoming these challenges may help to optimize performance and commercial viability of mixed metal oxide materials.

A sol-gel process is a method for producing solid materials from small molecules. The sol-gel method has emerged as a versatile and widely used technique for the synthesis of mixed metal oxides, owing to its ability to produce homogeneous materials at relatively low temperatures. Mixed metal oxides prepared via sol-gel methods exhibit enhanced properties, such as high surface area, tunable porosity, and improved catalytic activity, making them applicable in catalysis, sensors, photocatalysis, and energy storage. The process also allows for incorporation of different metal precursors into a uniform matrix, leading to better dispersion of the metal species and improved performance in applications; however, challenges, such as consistent porosity and scalability for industrial applications, remain.

Several materials prepared using the sol-gel method have faced challenges limiting their practical applications. Zirconia-titania mixed oxides, explored for catalysis, suffered from phase separation and poor crystallinity. Alumina-silica composites, developed for high-temperature use, encountered cracking and shrinkage during calcination. Ceria-zirconia oxides, used in oxygen storage, faced particle agglomeration, decreasing surface area and reactivity. These issues highlight the difficulties in controlling morphology, phase composition, and stability during sol-gel processing.

Accordingly, an object of the present disclosure to provide a mixed metal oxide nanocomposite comprising magnesium, titanium, oxygen, and boron. The nanocomposite, synthesized via a sol-gel process, is designed to create materials with uniform mesoporous structures and enhanced surface properties that may overcome shortcomings of the art.

### SUMMARY

In an exemplary embodiment, a mixed metal oxide nanocomposite is disclosed. The mixed metal oxide nanocomposite includes magnesium, titanium, boron, and oxygen. The magnesium, the titanium, and the oxygen form a first phase of magnesium titanium oxide (MgTi₂O₅). The magnesium, the boron, and the oxygen form a second phase of magnesium borate (Mg₃B₂O₆). The first phase and the second phase are present as a homogenous mixture of phases in the mixed metal oxide nanocomposite and have an orthorhombic crystal system. The mixed metal oxide nanocomposite is mesoporous with a mean pore diameter of 5 to 10 nm.

In some embodiments, the mixed metal oxide nanocomposite has a total pore volume of 0.2 to 0.3 cm³/g.

In some embodiments, the mixed metal oxide nanocomposite has a mean pore diameter of 6 to 7 nm.

In some embodiments, the mixed metal oxide nanocomposite has an average Brunauer-Emmett-Teller surface area of 70 to 80 m²/g.

In some embodiments, the mixed metal oxide nanocomposite has an average crystallite size of 60 to 70 nm.

In some embodiments, the first phase has an X-ray diffraction angle at 17 to 19° corresponding to a Miller index of (200).

In some embodiments, the first phase has an X-ray diffraction angle at 32 to 330 corresponding to a Miller index of (230).

In some embodiments, the first phase has an X-ray diffraction angle at 36 to 38° corresponding to a Miller index of (400).

In some embodiments, the first phase has an X-ray diffraction angle at 40 to 42° corresponding to a Miller index of (321).

In some embodiments, the first phase has an X-ray diffraction angle at 45 to 47° corresponding to a Miller index of (430).

In some embodiments, the first phase has an X-ray diffraction angle at 48 to 49° corresponding to a Miller index of (002).

In some embodiments, the first phase has an X-ray diffraction angle at 55 to 56° corresponding to a Miller index of (222).

In some embodiments, the first phase has an X-ray diffraction angle at 56 to 57° corresponding to a Miller index of (521).

In some embodiments, the first phase has an X-ray diffraction angle at 59 to 61° corresponding to a Miller index of (351).

In some embodiments, the first phase has an X-ray diffraction angle at 61 to 62° corresponding to a Miller index of (161).

In some embodiments, the first phase has an X-ray diffraction angle at 65 to 66° corresponding to a Miller index of (422).

In some embodiments, the first phase has an X-ray diffraction angle at 68 to 70° corresponding to a Miller index of (432).

In some embodiments, the second phase has X-ray diffraction angles at 25 to 26°, 52 to 53°, and 68 to 69° corresponding to Miller indices of (101), (202), and (251).

In some embodiments, the mixed metal oxide nanocomposite consists of MgTi₂O₅ and Mg₃B₂O₆.

In some embodiments, the mixed metal oxide nanocomposite is made by a process including dissolving a magnesium salt in water to form a first solution, dissolving boric acid in water to form a second solution, mixing the first solution and the second solution to form a third solution, mixing a titanium alkoxide and a first acid in an alcohol to form a fourth solution, mixing the third solution and the fourth solution to form a fifth solution, mixing a second acid and water to form a sixth solution, mixing the fifth solution and the sixth solution to form a seventh solution, adding ethylene glycol to the seventh solution to form an eighth solution, heating the eighth solution to a temperature of 110 to 130° C. to form a powder, and calcinating the powder at a temperature of 600 to 700° C. for 1 to 3 hours to form the mixed metal oxide nanocomposite.

These and other aspects of the non-limiting embodiments of the present disclosure will become apparent to those skilled in the art upon review of the following description of specific non-limiting embodiments of the disclosure in conjunction with the accompanying drawings. The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure (including alternatives and/or variations thereof) and many of the attendant advantages thereof will be readily obtained as the same becomes better understood by reference to the following detailed description when considered in connection with the accompanying drawings, wherein:

FIG. 1A is a flowchart depicting a method of synthesizing a mixed metal oxide nanocomposite including MgTi₂O₅ and Mg₃B₂O₆, according to certain embodiments.

FIG. 1B is a schematic flow diagram depicting experimental steps for the production of MgTi₂O₅/Mg₃B₂O₆ nanocomposite (the mixed metal oxide nanocomposite), according to certain embodiments.

FIG. 2 is an X-ray diffraction (XRD) pattern of the MgTi₂O₅/Mg₃B₂O₆ nanocomposite, according to certain embodiments.

FIG. 3 is a high-resolution transmission electron microscopy (HR-TEM) image of the MgTi₂O₅/Mg₃B₂O₆ nanocomposite, according to certain embodiments.

FIG. 4 is a nitrogen (N₂) adsorption/desorption isotherm of the MgTi₂O₅/Mg₃B₂O₆ nanocomposite, according to certain embodiments.

### DETAILED DESCRIPTION

In the following description, it is understood that other embodiments may be utilized, and structural and operational changes may be made without departure from the scope of the present embodiments disclosed herein.

Reference will now be made to specific embodiments or features, examples of which are illustrated in the accompanying drawings. In the drawings, whenever possible, corresponding or like reference numerals will be used to designate identical or corresponding parts throughout the several views. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a”, “an” and the like generally carry a meaning of “one or more”, unless stated otherwise.

Furthermore, the terms “approximately,” “approximate,” “about,” and similar terms generally refer to ranges that include the identified value within a margin of 20%, 10%, or preferably 5%, and any values therebetween. Within the description of this disclosure, where a numerical limit or range is stated, the endpoints are included unless stated otherwise. Also, all values and subranges within a numerical limit or range are specifically included as if explicitly written out.

As used herein, “particle size” and “pore size” may be considered the as a length or longest dimension of an individual particle and an individual pore opening, respectively.

As used herein, the term “degradation” refers to the removal of a substance from a system by breaking it down into smaller, simpler, and easier-to-eliminate by-products. Degradation may occur by physical, chemical, and/or any other means known in the art.

As used herein, the term “biodegradable” refers to any substance or material that can decompose and get resorbed into the environment, especially by the action of living organisms, such as bacteria, fungi, and other microorganisms.

As used herein, the term “organic” refers to a substance or material that can be produced from naturally occurring substances or materials. Organic may also refer to relating to or derived from living matter.

As used herein, the term “mixed metal oxide” refers to a composite material composed of two or more metallic ions and oxygen. Mixed metal oxides may be combined in ratios to achieve varying properties and/or functionalities. The mixed metal oxides may include various metal elements, such as lithium, beryllium, sodium, magnesium, aluminum, potassium, calcium, scandium, titanium, vanadium, chromium, manganese, iron, cobalt, nickel, copper, zinc, rubidium, strontium, yttrium, zirconium, niobium, molybdenum, technetium, ruthenium, rhodium, palladium, silver, cadmium, indium, tin, and others, which contribute to the overall performance of the nanocomposite.

As used herein, the term “nanocomposite” refers to a composite material that incorporates nanoscale components, typically ranging from 1 to 100 nanometers, within a matrix of a different material. These nanoscale components can include nanoparticles, nanofibers, and other nanostructures made from various materials, such as metals, oxides, polymers, and/or ceramics.

As used herein, the term “mesoporous” refers to materials that possess pores with diameters ranging from 2 to 50 nanometers. These materials may exhibit a hierarchical porous structure that allows for enhanced surface area and improved accessibility to internal pore networks. Mesoporous materials are characterized by their ability to facilitate the transport and/or adsorption of molecules. Mesoporous materials may be used in various applications, including catalysis, drug delivery, environmental remediation, and gas storage. The controlled pore size and structure of mesoporous materials may enable selective adsorption and provide advantages in enhancing reactivity, selectivity, and overall performance in chemical processes.

As used herein, the term “Miller indices” refers to a notation system in crystallography used to describe the orientation of crystallographic planes and directions in a crystal lattice. Miller indices are represented by a set of three integers (h, k, l) that correspond to intercepts of the plane with the crystallographic axes, which are denoted as x, y, and z. Each index is derived from a reciprocal of fractional intercepts that the plane makes with the axes, and they are typically expressed in the lowest terms. This system allows for the systematic classification of crystal structures and provides information regarding symmetry and geometry of a crystal, aiding in the identification and characterization of materials. Miller indices are used in fields such as materials science, solid-state physics, and mineralogy, as they help in understanding properties and behaviors of crystalline materials.

Aspects of the present disclosure are directed to a mixed metal oxide nanocomposite, MgTi₂O₅/Mg₃B₂O₆ (also referred to as a mixed metal oxide nanocomposite, a nanocomposite, and a MgTi₂O₅ and Mg₃B₂O₆ nanocomposite), and a method of synthesis using a sol-gel technique. The present disclosure addresses existing challenges by offering a straightforward and efficient sol-gel synthesis method for producing the mixed metal oxide nanocomposite. The method operates at moderate temperatures, which simplifies production processes and results in a uniform mesoporous nanocomposite with good crystallinity and structural properties. Reducing production costs and time may also increases the nanocomposite's potential for applications with high surface areas and varying pore structures, such as catalysis and adsorption, where traditional materials and methods have limitations.

Aspects of the present disclosure are directed to a mixed metal oxide nanocomposite comprising magnesium, titanium, boron, and oxygen. The magnesium, the titanium, and the oxygen form a first phase, MgTi₂O₅. The magnesium, the boron, and the oxygen form a second phase, Mg₃B₂O₆. The first phase and the second phase are present as a homogenous mixture of phases in the mixed metal oxide nanocomposite and have an orthorhombic crystal system. The mixed metal oxide nanocomposite is mesoporous with a mean pore diameter of 5 to 10 nm.

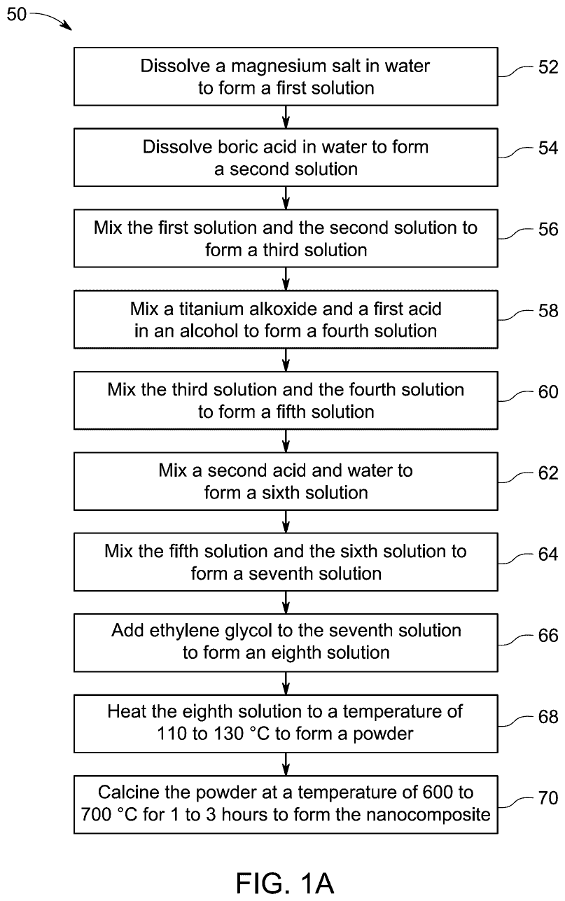

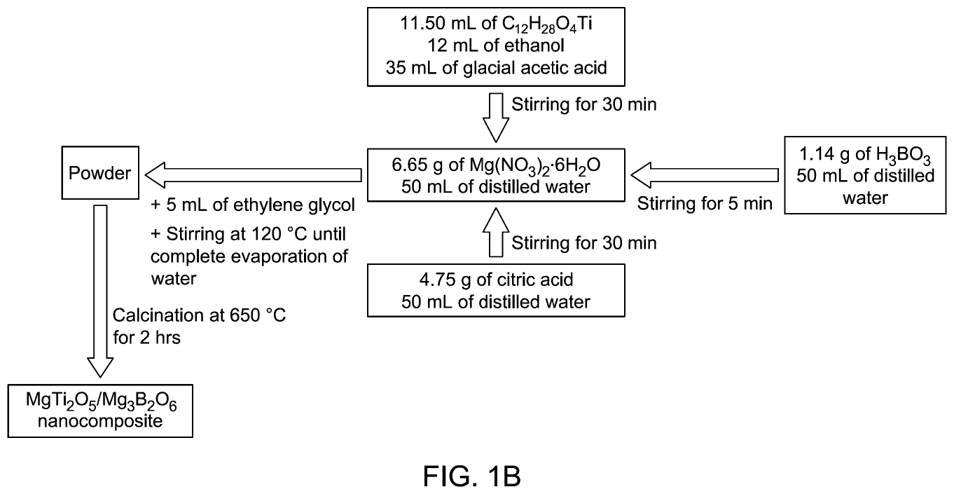

FIG. 1A illustrates a flowchart of a method 50 of synthesizing a mixed metal oxide nanocomposite. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes dissolving a magnesium salt in water to form a first solution. Dissolving the magnesium salt in water disperses magnesium ions uniformly in an aqueous medium, allowing for reactivity and interactions in subsequent steps. In certain embodiments, magnesium salts that may be used include, but are not limited to, magnesium sulfate (MgSO₄), magnesium chloride (MgCl₂), magnesium carbonate (MgCO₃), magnesium oxide (MgO), magnesium acetate (Mg(CH₃COO)₂), magnesium hydroxide (Mg(OH)₂), magnesium phosphate (Mg₃(PO₄)₂), magnesium nitrate (Mg(NO₃)₂), magnesium citrate (Mg₃(C₆H₅O₇)₂), magnesium fluoride (MgF₂), and magnesium bromide (MgBr₂). In a preferred embodiment, magnesium salt used is magnesium nitrate hexahydrate (Mg(NO₃)₂·6H₂O). Magnesium nitrate is used due to its high solubility in water, which facilitates the formation of a clear solution. The water acts as a solvent, dissociating the magnesium salt into its ionic components, Mg²⁺ and NO₃⁻, allowing the magnesium ions to be readily available for further reactions in the nanocomposite synthesis.

In some embodiments, the concentration of magnesium nitrate hexahydrate may range from 0.01 to 2.0 moles per liter (M), preferably 0.05 to 1.5 M, preferably 0.1 to 1.0 M, preferably 0.2 to 0.8 M, more preferably 0.4 to 0.6 M, and yet more preferably 0.5 to 0.55 M. In a preferred embodiment, the concentration of magnesium nitrate hexahydrate is about 0.518 M.

At step 54, the method 50 includes dissolving boric acid in water to form a second solution.

This step incorporates boron into the reaction mixture, facilitating the formation of the boron-containing phase in the nanocomposite. Boric acid is highly soluble in water, dissociating into borate ions, which can react with other components during the synthesis process. In some embodiments, other sources of boron may be used alone or in combination with boric acid. In some embodiments, other sources of boron include, but are not limited to, sodium borate (Na₂B₄O₇), boron oxide (B₂O₃), boron nitride (BN), boron trifluoride (BF₃), boron phosphate (BPO₄), boron carbide (B₄C), potassium tetrafluoroborate (KBF₄), ammonium pentaborate ((NH₄)B₅O₈), zinc borate (Zn₄O₃(BO₃)₂), aluminum borate (Al₄B₂O₉), and the like. In a preferred embodiment, a boron source used is boric acid. When boric acid is dissolved in water, it dissociates to release borate ions (BO₃³⁻), which can interact with other metal ions in the reaction, such as magnesium, to form a borate structure in the nanocomposite.

In some embodiments, the concentration of boric acid may range from 0.01 to 2.0 M, preferably 0.05 to 1.5 M, preferably 0.1 to 1.0 M, preferably 0.2 to 0.8 M, more preferably 0.3 to 0.5 M, and yet more preferably 0.35 to 0.4 M. In a preferred embodiment, the concentration of boric acid is about 0.369 M.

At step 56, the method 50 includes mixing the first solution and the second solution to form a third solution. The first solution, containing magnesium nitrate hexahydrate, is mixed with the second solution of boric acid in the synthesis process. This combination facilitates interactions between magnesium ions (Mg²⁺) and borate ions (BO₃³⁻), promoting formations of magnesium borate compounds, which are in the nanocomposite.

In some embodiments, the first solution and the second solution may be mixed for a duration of 1 minute to 30 minutes (min), preferably 2 to 20 min, more preferably 3 to 10 min, and yet more preferably 4 to 6 min. In a preferred embodiment, the first solution and the second solution are mixed for about 5 min.

At step 58, the method 50 includes mixing a titanium alkoxide and a first acid in an alcohol to form a fourth solution. Titanium alkoxides, are reactive compounds that may serve as precursors for titanium incorporation due to their ability to readily hydrolyze and form titanium dioxide (TiO₂) upon reaction with moisture in the environment. The use of a first acid plays a role in stabilizing the titanium alkoxide during the mixing process. The acid can facilitate the formation of a more stable titanium species and promote the solubility of the titanium precursor in the alcohol solvent, often ethanol. The alcohol not only acts as a solvent but may also help to control the reactivity and hydrolysis of the titanium alkoxide, enabling a more controlled and uniform reaction environment.

In some embodiments, the titanium alkoxides that may be used include, but are not limited to, titanium butoxide (Ti(OBu)₄), titanium ethoxide (Ti(OEt)₄), titanium methoxide (Ti(OMe)₄), titanium propoxide (Ti(OPn)₄), titanium octoxide (Ti(OOct)₄), titanium phenoxide (Ti(OPh)₄), titanium isobutoxide (Ti(OiBu)₄), titanium n-butoxide (Ti(OnBu)₄), titanium n-propoxide (Ti(OnPr)₄), titanium cyclohexoxide (Ti(OCH₃)₄), titanium 2-ethylhexoxide (Ti(O₂-EH)₄), titanium trifluoroethoxide (Ti(OCH₂CF₃)₄), titanium 4-methylpentoxide (Ti(O₄-MP)₄), titanium 3-phenylpropoxide (Ti(O₃-PhPr)₄), and titanium 2-methoxyethoxide (Ti(O₂-ME)₄). In a preferred embodiment, the titanium alkoxide used is titanium isopropoxide (Ti(OC₃H₇)₄). In some embodiments, various titanium materials, such as titanium salts, may be used in place or in combination with the titanium alkoxide.

In some embodiment, the first acid may include, but is not limited to, at least one of hydrochloric acid (HCl), sulfuric acid (H₂SO₄), nitric acid (HNO₃), phosphoric acid (H₃PO₄), citric acid (C₆H₈O₇), acetic acid (CH₃COOH), formic acid (HCOOH), tartaric acid (C₄H₆O₆), maleic acid (C₄H₄O₄), lactic acid (C₃H₆O₃), benzoic acid (C₇H₆O₂), oxalic acid (C₂H₂O₄), propionic acid (C₃H₆O₂), stearic acid (C₁₈H₃₆O₂), fumaric acid (C₄H₄O₄), succinic acid (C₄H₆O₄), and the like. In a preferred embodiment, the first acid is acetic acid, preferably a glacial acetic acid.

In some embodiments, the alcohol may include, but is not limited to, methanol (CH₃OH), ethanol (C₂H₆O), isopropanol (C₃H₈O), n-butanol (C₄H₁₀O), isobutanol (C₄H₁₀O), n-pentanol (C₅H₁₂O), isoamyl alcohol (C₅H₁₂O), hexanol (C₆H₁₄O), heptanol (C₇H₁₆O), octanol (C₈H₁₈O), nonanol (C₉H₂₀O), decanol (C₁₀H₂₂O), benzyl alcohol (C₇H₈O), cyclohexanol (C₆H₁₂O), allyl alcohol (C₃H₆O), glycerol (C₃H₈O₃), phenyl ethanol (C₈H₁₀O), a combination thereof, and the like. In a preferred embodiment, alcohol used is ethanol.

In some embodiments, a volume-by-volume percentage (v/v %) of titanium isopropoxide in the fourth solution may range from 10 to 30%, preferably 12 to 26%, preferably 15 to 23%, more preferably 18 to 22%, and yet more preferably 19 to 20%. In a preferred embodiment, the v/v % of titanium isopropoxide is about 19.6%.

In some embodiments, the v/v % of ethanol in the fourth solution may range from 10 to 30%, preferably 12 to 28%, preferably 14 to 26%, preferably 16 to 24%, more preferably 18 to 22%, and yet more preferably 19 to 21%. In a preferred embodiment, the v/v % of ethanol is about 20.5%.

In some embodiments, the v/v % of glacial acetic acid in the fourth solution may range from 50 to 70%, preferably 52 to 68%, preferably 54 to 66%, preferably 56 to 64%, more preferably 58 to 62%, and yet more preferably 59 to 61%. In a preferred embodiment, the v/v % of glacial acetic acid is about 59.6%.

At step 60, the method 50 includes combining the third solution, which contains magnesium and boron precursors, with the fourth solution, which consists of titanium alkoxide and an acid-alcohol mixture, to form a fifth solution. Step 60 initiates interactions between magnesium, boron, and titanium, facilitating a distribution of each element within the reaction mixture. Controlled mixing of these solutions promotes the components to be evenly dispersed, encouraging uniform nucleation and growth of the MgTi₂O₅/Mg₃B₂O₆ nanocomposite. The presence of the titanium alkoxide in the fourth solution, in combination with the boric acid and magnesium salt in the third solution, sets the stage for complex formation and subsequent reactions that lead to the formation of the nanocomposite.

In some embodiments, the third solution and the fourth solution may be mixed for a duration of 1 to 60 min, preferably 5 to 50 min, preferably 10 to 45 min, more preferably 20 to 40 min, and yet more preferably 25 to 35 min. In a preferred embodiment, the mixing of the third solution and the fourth solution is conducted for about 30 min.

At step 62, the method 50 includes mixing a second acid and water to form a sixth solution. In some embodiment, second acid may include one of hydrochloric acid (HCl), sulfuric acid (H₂SO₄), nitric acid (HNO₃), phosphoric acid (H₃PO₄), acetic acid (CH₃COOH), formic acid (HCOOH), oxalic acid (C₂H₂O₄), malic acid (C₄H₆O₅), tartaric acid (C₄H₆O₆), lactic acid (C₃H₆O₃), succinic acid (C₄H₆O₄), ascorbic acid (C₆H₈O₆), glycolic acid (C₂H₄O₃), fumaric acid (C₄H₄O₄), benzoic acid (C₇H₆O₂), citric acid, a combination thereof, and the like. In a preferred embodiment, the second acid is citric acid. Citric acid acts as a chelating agent, binding with metal ions from the magnesium, boron, and titanium precursors to form stable complexes. Citric acid also plays a role in influencing the gelation process, facilitating the formation of a more uniform and stable gel structure during the subsequent stages of the synthesis.

In some embodiments, the concentration of citric acid may range from 0.01 to 2.0 M, preferably 0.05 to 1.5 M, preferably 0.1 to 1.2 M, preferably 0.2 to 1.0 M, more preferably 0.3 to 0.8 M, and yet more preferably 0.4 to 0.6 M. In a preferred embodiment, the concentration of citric acid is about 0.5 M.

At step 64, the method 50 includes mixing the fifth solution, which contains the precursors of magnesium, boron, and titanium, with the sixth solution, containing citric acid dissolved in water, to form a seventh solution. This step integrates stabilizing and chelating effects of the citric acid with the metal-containing components. The combination of these solutions promotes a uniform distribution of metal ions, as the citric acid in the sixth solution acts as a chelating agent, binding to the metal ions in the fifth solution. This chelation helps to stabilize the metal ions and prevents premature precipitation, encouraging that they remain in solution.

In some embodiments, the mixing may be performed for durations of 1 to 60 min, preferably 5 to 50 min, preferably 10 to 45 min, more preferably 20 to 40 min, and yet more preferably 25 to 35 min. In a preferred embodiment, the mixing is conducted for about 30 min.

At step 66, the method 50 includes adding ethylene glycol to the seventh solution to form an eighth solution. In step 66, ethylene glycol acts as a stabilizing and coordinating agent, which facilitates the formation of a homogeneous mixture by enhancing the solubility of the components and promoting effective interactions among them. The incorporation of ethylene glycol not only aids in maintaining the desired viscosity of the solution but also plays a role in influencing the morphology of the final nanocomposite product. By enabling better dispersion of the metal ions within the solution, ethylene glycol helps to achieve a uniform distribution of magnesium, titanium, and boron in the subsequent steps.

In some embodiments, other stabilizing and coordinating agents may be used in place of or in combination with ethylene glycol, such as glycerol, polyvinyl alcohol (PVA), polyethylene glycol (PEG), 1,2-propylene glycol, triethylene glycol, sorbitol, maltose, glucose, citric acid, ammonium acetate, acetic acid, sodium citrate, 2-pyrrolidinone, dimethyl sulfoxide (DMSO), ethanolamine, a combination thereof, and the like.

At step 68, the method 50 includes heating the eighth solution to a temperature of 110 to 130° C., preferably 111 to 129° C., preferably 112 to 128° C., preferably 113 to 127° C., preferably 114 to 126° C., preferably 115 to 125° C., preferably 116 to 124° C., preferably 117 to 123° C., preferably 118 to 122° C., more preferably 119 to 121° C., and yet more preferably about 120° C. to form a powder. This thermal treatment drives off the water content and facilitates the evaporation of the solvent, resulting in the formation of a viscous gel-like precursor.

At step 70, the method 50 includes calcinating the powder at a temperature of 600 to 700° C. for 1 to 3 hours to form the nanocomposite. This calcination process transforms an amorphous or gel-like precursor into a crystalline nanocomposite, specifically MgTi₂O₅/Mg₃B₂O₆. During calcination, elevated temperatures facilitate decomposition of residual organic materials, such as citric acid and ethylene glycol, that may have remained from the earlier synthesis steps. This thermal treatment promotes crystallization of the phases by promoting diffusion of ions and enabling solid-state reactions between the constituent materials.

In some embodiments, the powder may be calcined at various temperature ranges, including 600 to 700° C., preferably 610 to 690° C., preferably 620 to 680° C., more preferably 630 to 670° C., and yet more preferably 640 to 660° C. In a preferred embodiment, calcinating the powder is conducted at a temperature of about 650° C.

In some embodiments, the powder may be calcined for various time period ranges, including 1 to 3 hours, preferably 1.1 to 2.9 hours, preferably 2.2 to 2.8 hours, more preferably 2.3 to 2.7 hours, and yet more preferably about 2.4 to 2.6 hours. In a preferred embodiment, the calcinating the powder is conducted for about 2 hours.

The mixed metal oxide nanocomposite is composed of two distinct phases: MgTi₂O₅ and Mg₃B₂O₆. This mixed metal oxide nanocomposite contains magnesium, titanium, boron, and oxygen arranged in such a way that they facilitate the formation of these two phases. In the first phase, magnesium and titanium combine with oxygen to create a MgTi₂O₅ material and/or phase, which is characterized by its structural properties that contribute to the overall functionality of the nanocomposite. The second phase, Mg₃B₂O₆, is formed when magnesium interacts with boron and oxygen, further varying the material's properties through the incorporation of boron. The mixed metal oxide nanocomposite comprises a homogenous mixture of phases, where both MgTi₂O₅ and Mg₃B₂O₆ coexist uniformly within the nanocomposite. This homogeneity promotes beneficial properties of each phase being retained and synergistically contributing to the material's performance.

In some embodiments, the mixed metal oxide nanocomposite may exhibit various crystal systems, including cubic, tetragonal, hexagonal, rhombohedral, monoclinic, triclinic, orthorhombic, a combination thereof, and the like. In a preferred embodiment, the mixed metal oxide nanocomposite displays an orthorhombic crystal system.

In some embodiments, the crystallite size of mixed metal oxide nanocomposite may be in range from 60-70 nm, preferably 61-69 nm, preferably 62-68 nm, preferably 63-67 nm, more preferably 64-66 nm, and yet more preferably about 65.23 nm.

In some embodiments, the first phase, MgTi₂O₅, of the mixed metal oxide nanocomposite has an X-ray diffraction angle ranging from 17 to 19°, preferably 17.5 to 18.5°, more preferably 18 to 18.3°, and yet more preferably about 18.2° 18.18°, which corresponds to a Miller index of (200).

In some embodiments, the first phase of the mixed metal oxide nanocomposite has an X-ray diffraction angle ranging from 32 to 33°, preferably 32.2 to 32.8°, preferably 32.4 to 32.7°, more preferably 32.5 to 32.6°, and yet more preferably about 32.59°, which corresponds to a Miller index of (230).

In some embodiments, the first phase of the mixed metal oxide nanocomposite has an X-ray diffraction angle ranging from 36 to 38°, preferably 36.2 to 37.8°, preferably 36.4 to 37.6°, preferably 36.6 to 37.4°, preferably 36.7 to 37.2°, more preferably 36.8 to 37°, and yet more preferably about 36.89°, which corresponds to a Miller index of (400).

In some embodiments, the first phase of the mixed metal oxide nanocomposite has an X-ray diffraction angle ranging from 40 to 42°, preferably 40.2 to 41.8°, preferably 40.4 to 41.6°, preferably 40.6 to 41.4°, preferably 40.8 to 41.2°, more preferably 40.9 to 41.1°, and yet more preferably about 41.03°, which corresponds to a Miller index of (321).

In some embodiments, the first phase of the mixed metal oxide nanocomposite has an X-ray diffraction angle ranging from 45 to 47°, preferably 45.2 to 46.9°, preferably 45.4 to 46.8°, preferably 45.6 to 46.7°, preferably 45.8 to 46.6°, preferably 46 to 46.5°, more preferably 46.2 to 46.5°, and yet more preferably about 46.27°, which corresponds to a Miller index of (430).

In some embodiments, the first phase of the mixed metal oxide nanocomposite has an X-ray diffraction angle ranging from 48 to 49°, preferably 48.1 to 48.9°, preferably 48.2 to 48.8°, preferably 48.4 to 48.75°, more preferably 48.6 to 48.7°, and yet more preferably about 48.66°, which corresponds to a Miller index of (002).

In some embodiments, the first phase of the mixed metal oxide nanocomposite has an X-ray diffraction angle ranging from 55 to 56°, preferably 55.1 to 55.9°, preferably 55.2 to 55.8°, preferably 55.3 to 55.7°, more preferably 55.4 to 55.6°, and yet more preferably about 55.54°, which corresponds to a Miller index of (222).

In some embodiments, the first phase of the mixed metal oxide nanocomposite has an X-ray diffraction angle ranging from 56 to 57°, preferably 56.05 to 56.8°, preferably 56.1 to 56.6°, preferably 56.15 to 56.4°, more preferably 56.2 to 56.3°, and yet more preferably about 56.27°, which corresponds to a Miller index of (521).

In some embodiments, the first phase of the mixed metal oxide nanocomposite has an X-ray diffraction angle ranging from 59 to 61°, preferably 59.2 to 60.8°, preferably 59.4 to 60.6°, preferably 59.6 to 60.4°, preferably 59.7 to 60.2°, more preferably 59.8 toto 60°, and yet more preferably about 59.87°, which corresponds to a Miller index of (351).

In some embodiments, the first phase of the mixed metal oxide nanocomposite has an X-ray diffraction angle ranging from 61 to 62°, preferably 61.1 to 61.9°, preferably 61.2 to 61.8°, preferably 61.3 to 61.7°, more preferably 61.5 to 61.65°, and yet more preferably about 61.61°, which corresponds to a Miller index of (161).

In some embodiments, the first phase of the mixed metal oxide nanocomposite has an X-ray diffraction angle ranging from 65 to 66°, preferably 65.1 to 65.9°, preferably 65.2 to 65.8°, preferably 65.3 to 65.7°, more preferably 65.4 to 65.6°, and yet more preferably about 65.55°, which corresponds to a Miller index of (422).

In some embodiments, the first phase of the mixed metal oxide nanocomposite has an X-ray diffraction angle ranging from 68 to 70°, preferably 68.2 to 69.9°, preferably 68.4 to 69.8°, preferably 68.6 to 69.7°, preferably 68.8 to 69.6°, preferably 69 to 69.5°, more preferably 69.2 to 69.4°, and yet more preferably about 69.310, which corresponds to a Miller index of (432).

In some embodiments, the second phase, Mg₃B₂O₆, of the mixed metal oxide nanocomposite has an X-ray diffraction angles ranging from 25 to 26°, preferably 25.1 to 25.9°, preferably 25.2 to 25.8°, preferably 25.3 to 25.6°, more preferably 25.35 to 25.5°, and yet more preferably about 25.42°; ranging from 52 to 53°, preferably 52.05 to 52.9°, preferably 52.1 to 52.8°, preferably 52.15 to 52.7°, preferably 52.2 to 52.6°, preferably 52.25 to 52.5, more preferably 52.3 to 52.4°, and yet more preferably about 52.33°; and ranging from 68 to 69°, preferably 68.1 to 68.9°, preferably 68.2 to 68.8°, preferably 68.3 to 68.7°, more preferably 68.5 to 68.6°, and yet more preferably about 68.58°, which correspond to Miller indices of (101), (202), and (251), respectively.

In some embodiments, the mixed metal oxide nanocomposite may exhibit a range of morphological shapes, including, but not limited to, nanocrystals, nanorectangles, nanotriangles, nanopentagons, nanohexagons, nanoprisms, nanodisks, nanocubes, nanoribbons, nanoblocks, nanobeads, nanoflakes, nanopowders, nanoflowers, mixtures thereof, and the like. In a preferred embodiment, the morphological structures of mixed metal oxide nanocomposite particles possess an irregular shape with an agglomerated structure.

In some embodiments, the mixed metal oxide nanocomposite has an average Brunauer-Emmett-Teller (BET) surface area ranging from 70 to 80 m²/g, preferably 71 to 79 m²/g, preferably 72 to 78 m²/g, more preferably 74 to 77 m²/g, and yet more preferably 75 to 76 m²/g. In a preferred embodiment, the mixed metal oxide nanocomposite has an average surface area of about 75.92 m²/g.

In some embodiments, the mixed metal oxide nanocomposite has a mean pore diameter ranging from 6 to 7 nm, preferably 6.1 to 6.9 nm, preferably 6.2 to 6.8 nm, preferably 6.3 to 6.7 nm, more preferably 6.4 to 6.65 nm, and yet more preferably about 6.5 to 6.6 nm. In a preferred embodiment, the mixed metal oxide nanocomposite has a mean pore diameter of about 6.58 nm.

In some embodiments, the mixed metal oxide nanocomposite has a mean pore diameter ranging from 5 to 10 nm, preferably 5.5 to 9 nm, preferably 6 to 8 nm, preferably 6.2 to 7 nm, more preferably 6.4 to 6.7 nm, and yet more preferably about 6.58 nm.

In some embodiments, the mixed metal oxide nanocomposite has a total pore volume ranging from 0.2 to 0.3 cm³/g, preferably 0.21 to 0.29 cm³/g, preferably 0.22 to 0.28 cm³/g, preferably 0.23 to 0.27 cm³/g, more preferably 0.24 to 0.26 cm³/g, and yet more preferably about 0.25 to 0.258 cm³/g. In a preferred embodiment, the mixed metal oxide nanocomposite has a total pore volume of about 0.2562 cm³/g.

In some embodiments, the mixed metal oxide nanocomposite has an average crystallite size of 60 to 70 nm, preferably 61 to 69 nm, preferably 62 to 68 nm, preferably 63 to 67 nm, preferably 64 to 66 nm, more preferably about 65 to 65.5 nm, and yet more preferably about 65.23 nm.

The mesoporous structure and high surface area of the MgTi₂O₅ and Mg₃B₂O₆ nanocomposite is suitable for various commercial applications. In one example, the high surface area and uniform porosity enhance performance of the MgTi₂O₅ and Mg₃B₂O₆ nanocomposite as a catalyst and/or catalyst support in various chemical reactions. In another example, the mesoporous nature of the MgTi₂O₅ and Mg₃B₂O₆ nanocomposite helps in adsorption processes, such as the removal of pollutants from water and/or air, offering high efficiency in capturing contaminants due to its large pore volume. In yet another example, the MgTi₂O₅ and Mg₃B₂O₆ nanocomposite may be used in developing advanced materials with enhanced properties, such as increased thermal stability, mechanical strength, and/or chemical resistance, making it applicable for coatings, membranes, and other applications.

### EXAMPLES

The disclosure will now be illustrated with working examples, which are intended to illustrate the working of the disclosure and not intended to restrictively imply any limitations on the scope of the present disclosure, as many variations thereof are possible without departing from the spirit and scope of the present disclosure. The following examples demonstrate a mixed metal oxide nanocomposite comprising MgTi₂O₅ and Mg₃B₂O₆ and preparation using a sol-gel method.

The examples are provided solely for illustration and are not to be construed as limitations of the present disclosure.

### Example 1: Materials

All chemicals used in the present disclosure were purchased from Sigma-Aldrich Chemical Company. Boric acid (HB₃O₃), magnesium nitrate hexahydrate (Mg(NO₃)₂·6H₂O), titanium isopropoxide (C₁₂H₂₈O₄Ti), citric acid (C₆H₈O₇), ethanol (C₂H₅OH), ethylene glycol (C₂H₆O₂), and glacial acetic acid (CH₃COOH) were employed as reagents in the synthesis of the MgTi₂O₅ and Mg₃B₂O₆ nanocomposite.

### Example 2: Synthesis of MgTi₂O₅ and Mg₃B₂O₆ Nanocomposite Using Sol-Gel Method

As shown in FIG. 1B, to synthesize the MgTi₂O₅ and Mg₃B₂O₆ nanocomposite, 6.65 g of magnesium nitrate hexahydrate (Mg(NO₃)₂·6H₂O) was first dissolved in 50 mL of distilled water. Separately, 1.14 g of boric acid (H₃BO₃) was dissolved in another 50 mL of distilled water, and this solution was added to the magnesium nitrate solution with constant stirring for 5 minutes (min). Separately, 11.50 mL of titanium isopropoxide was dissolved using a mixture of 12 mL of ethanol and 35 mL of glacial acetic acid, and this solution was added to the previously prepared mixture of magnesium nitrate and boric acid with continuous stirring for 30 min. Following this, 4.75 g of citric acid was dissolved in 50 mL of distilled water, and this solution was added to the reaction mixture with continuous stirring for another 30 min. Subsequently, 5 mL of ethylene glycol was added to the mixture, which was then heated with stirring at 120° C. until complete evaporation of water occurred. The resultant powder was calcined at 650° C. for 2 hours to obtain the MgTi₂O₅ and Mg₃B₂O₆ nanocomposite.

The synthesized nanocomposite was characterized using X-ray diffraction (XRD), N₂ adsorption and desorption analysis, and high-resolution transmission electron microscopy (HR-TEM).

### Example 3: X-Ray Diffraction (XRD)

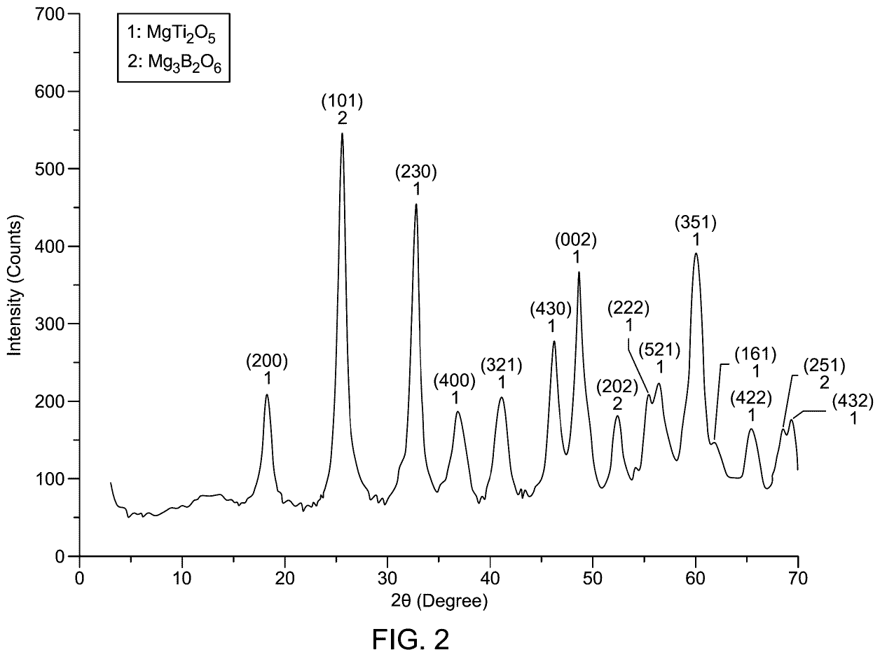

The synthesized nanocomposite comprises MgTi₂O₅ and Mg₃B₂O₆, both with an orthorhombic crystal system as indicated by JCPDS No. 00-035-0796 and JCPDS No. 00-038-1475, respectively, as shown in FIG. 2. The XRD analysis of MgTi₂O₅ shows diffraction angles at 18.18°, 32.59°, 36.89°, 41.03°, 46.27°, 48.66°, 55.54°, 56.27°, 59.87°, 61.61°, 65.55°, and 69.310, which correspond to Miller indices (200), (230), (400), (321), (430), (002), (222), (521), (351), (161), (422), and (432), respectively. For Mg₃B₂O₆, diffraction angles are observed at 25.42°, 52.33°, and 68.58°, with the corresponding Miller indices being (101), (202), and (251), respectively. The average crystallite size of the sample was determined to be 65.23 nm.

### Example 4: High-Resolution Transmission Electron Microscopy (HR-TEM)

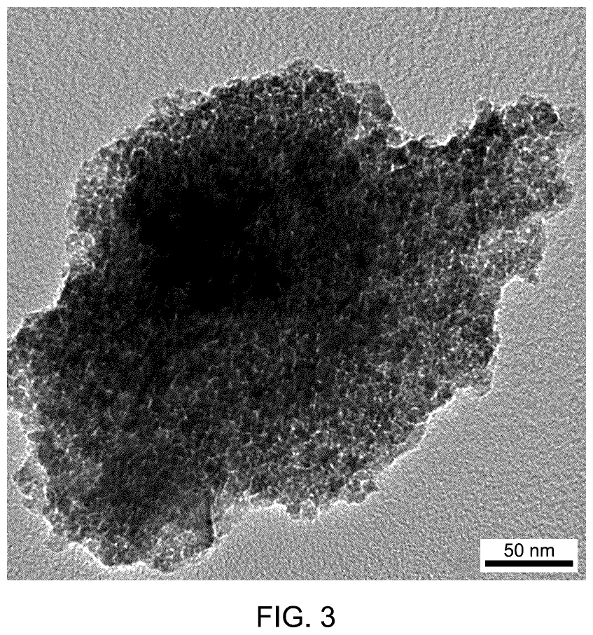

FIG. 3 shows an HR-TEM image of the MgTi₂O₅/Mg₃B₂O₆ nanocomposite and illustrates the morphology of the synthesized particles. The HR-TEM image reveals that the nanocomposite particles possess an irregular shape with an agglomerated structure, which is seen in materials synthesized via a sol-gel method. The particles are uniformly distributed with a high level of crystallinity, as observed from the clear lattice fringes seen in the HR-TEM image.

### Example 5: Brunauer-Emmett-Teller (BET) for Surface Textures

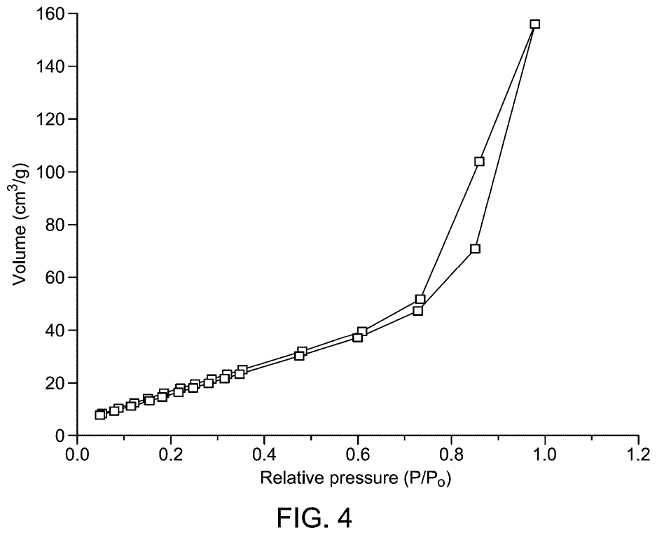

FIG. 4 illustrates the N₂ adsorption and desorption isotherm of the MgTi₂O₅/Mg₃B₂O₆ nanocomposite, which exhibits a type IV isotherm pattern of mesoporous materials. The adsorption curve shows a gradual increase in volume at lower relative pressures, followed by a steep rise at higher pressures, indicating capillary condensation within the mesopores. Table 1 details the surface textures of the MgTi₂O₅/Mg₃B₂O₆ nanocomposite, highlighting a BET surface area of 75.92 m²/g, a total pore volume of 0.2562 cm³/g, and a mean pore diameter of 6.58 nm.

The large mean pore diameter supports the mesoporous nature of the material, as the pore sizes exceed 2 nm, supporting the classification of the pores as mesopores. The combination of a moderate surface area and a large pore volume further supports the nanocomposite's potential for applications benefiting from mesoporous structures.

TABLE 1
Surface textures of MgTi₂O₅ and Mg₃B₂O₆ nanocomposite

| BET surface area | Total pore volume | Mean pore diameter |
|---|---|---|
| (m²/g) | (cm³/g) | (nm) |
| 75.92 | 0.2562 | 6.58 |

The present disclosure relates to the synthesis of MgTi₂O₅ and Mg₃B₂O₆ nanocomposite using a sol-gel method The synthesis results in a mesoporous nanocomposite characterized by a total pore volume of 0.2562 cm³/g and a mean pore diameter of 6.58 nm, which support its mesoporous nature. Additionally, the nanocomposite exhibits a BET surface area of 75.92 m²/g and an average crystal size of 65.23 nm, providing surface characteristics for various applications. The MgTi₂O₅ and Mg₃B₂O₆ nanocomposite combines magnesium titanium oxide and magnesium borate phases, offering properties not achievable with existing materials. The combination of a high surface area, mesoporosity, and uniform particle sizes of the nanocomposite is suitable for applications in catalysis, adsorption, and other advanced material technologies. The present disclosure addresses the limitations of existing nanocomposites by providing a material with improved performance characteristics, meeting the growing demand for efficient and effective nanomaterials in industrial applications.

Numerous modifications and variations of the present disclosure are possible in light of the above teachings. It is, therefore, to be understood that within the scope of the appended claims, the disclosure may be practiced otherwise than as specifically described herein.

1: A mixed metal oxide nanocomposite, comprising:
magnesium;
titanium;
boron; and
oxygen,
wherein the magnesium, the titanium, and the oxygen form a first phase, MgTi₂O₅,
wherein the magnesium, the boron, and the oxygen form a second phase, Mg₃B₂O₆,
wherein the first phase and the second phase are present as a homogenous mixture of phases in the mixed metal oxide nanocomposite and have an orthorhombic crystal system,
wherein the mixed metal oxide nanocomposite is mesoporous with a mean pore diameter of 5 to 10 nm.

2: The mixed metal oxide nanocomposite of claim 1, having a total pore volume of 0.2 to 0.3 cm³/g.

3: The mixed metal oxide nanocomposite of claim 1, having a mean pore diameter of 6 to 7 nm.

4: The mixed metal oxide nanocomposite of claim 1, having an average Brunauer-Emmett-Teller surface area of 70 to 80 m²/g.

5: The mixed metal oxide nanocomposite of claim 1, having an average crystallite size of 60 to 70 nm.

6: The mixed metal oxide nanocomposite of claim 1, wherein the first phase has an X-ray diffraction angle at 17 to 190 corresponding to a Miller index of (200).

7: The mixed metal oxide nanocomposite of claim 1, wherein the first phase has an X-ray diffraction angle at 32 to 330 corresponding to a Miller index of (230).

8: The mixed metal oxide nanocomposite of claim 1, wherein the first phase has an X-ray diffraction angle at 36 to 380 corresponding to a Miller index of (400).

9: The mixed metal oxide nanocomposite of claim 1, wherein the first phase has an X-ray diffraction angle at 40 to 420 corresponding to a Miller index of (321).

10: The mixed metal oxide nanocomposite of claim 1, wherein the first phase has an X-ray diffraction angle at 45 to 470 corresponding to a Miller index of (430).

11: The mixed metal oxide nanocomposite of claim 1, wherein the first phase has an X-ray diffraction angle at 48 to 490 corresponding to a Miller index of (002).

12: The mixed metal oxide nanocomposite of claim 1, wherein the first phase has an X-ray diffraction angle at 55 to 560 corresponding to a Miller index of (222).

13: The mixed metal oxide nanocomposite of claim 1, wherein the first phase has an X-ray diffraction angle at 56 to 570 corresponding to a Miller index of (521).

14: The mixed metal oxide nanocomposite of claim 1, wherein the first phase has an X-ray diffraction angle at 59 to 610 corresponding to a Miller index of (351).

15: The mixed metal oxide nanocomposite of claim 1, wherein the first phase has an X-ray diffraction angle at 61 to 620 corresponding to a Miller index of (161).

16: The mixed metal oxide nanocomposite of claim 1, wherein the first phase has an X-ray diffraction angle at 65 to 660 corresponding to a Miller index of (422).

17: The mixed metal oxide nanocomposite of claim 1, wherein the first phase has an X-ray diffraction angle at 68 to 700 corresponding to a Miller index of (432).

18: The mixed metal oxide nanocomposite of claim 1, wherein the second phase has X-ray diffraction angles at 25 to 26°, 52 to 53°, and 68 to 690 corresponding to Miller indices of (101), (202), and (251).

19: The mixed metal oxide nanocomposite of claim 1, consisting of MgTi₂O₅ and Mg₃B₂O₆.

20: The mixed metal oxide nanocomposite of claim 1, wherein the nanocomposite is made by a process comprising:
dissolving a magnesium salt in water to form a first solution;
dissolving boric acid in water to form a second solution;
mixing the first solution and the second solution to form a third solution;
mixing a titanium alkoxide and a first acid in an alcohol to form a fourth solution;
mixing the third solution and the fourth solution to form a fifth solution;
mixing a second acid and water to form a sixth solution;
mixing the fifth solution and the sixth solution to form a seventh solution;
adding ethylene glycol to the seventh solution to form an eighth solution;
heating the eighth solution to a temperature of 110 to 130° C. to form a powder; and
calcinating the powder at a temperature of 600 to 700° C. for 1 to 3 hours to form the nanocomposite.
